(19) United States
(12) Patent Application Publication
(10) Pub. No.: US 2016/0146729 A1
(43) Pub. Date: May 26, 2016

(54) MEASUREMENT METHOD BASED ON AN OPTICAL WAVEGUIDE SENSOR SYSTEM

(71) Applicant: CSEM Centre Suisse d'Electronique et de Microtechnique SA - Recherche et Développement, Neuchâtel (CH)

(72) Inventors: Florian Kehl, Chur (CH); Stéphane Follonier, Vilters (CH)

(21) Appl. No.: 14/897,790

(22) PCT Filed: Jun. 5, 2014
(86) PCT No.: PCT/EP2014/061740

§ 371 Date: Dec. 11, 2015

(30) Foreign Application Priority Data
Jun. 12, 2013 (CH) 1112/13

(51) Int. Cl. G01N 21/41

(52) U.S. Cl. CPC G01N 21/41; G01N 2201/088

(57) ABSTRACT

A method for measuring a value change of a parameter at the sensing area of an optical sensor element. The method includes the steps:

changing the value of the parameter thereby detecting the position and position change of a first signal peak within the detection window of a detector as well as thereby detecting the position and the eventual position change of a second signal peak within the detection window of the detector, and
correlating the position detections of first and second signal peak and correlating the position change detections of first and second signal peak and attributing a value and/or a value change to the correlated detections

Ad- and desorption of (bio) chemical substances, changes of liquids, pH, stress/strain or even temperature changes can be detected at the surface of optical sensors through monitoring of changes of their effective refractive index. Besides the detection the refractive index, these optical “refractive index change” detection systems are also used to detect attenuation at or near the interface of the sensor.

Standard optical “refractive index change” detection systems rely on only one signal peak to track time-dependent changes of their interface in a single or in an array format. Sometimes an additional channel for referencing is foreseen.

Surface Plasmon Resonance (SPR), Waveguide Grating (WGG), Total Internal Reflectance

(TIR), Ellipsometric (ELLI), Multilayer Dielectric Systems (MDS), Photonic Bandgap Crystal (PBC) and Bragg Grating (BG) biosensors are well known and available in different sensing configurations on the market for the detection of “refractive index change” at the sensor surface. When used for the detection of ad- and desorption of (bio) chemical substances in the Life Science market, these sensors are not only capable of revealing the amount of substance present at the surface, but also give insight into the time dependent binding/adsorption behavior (kinetics) of the substances (“analyte”) to the surface or to a present substance (“ligand”) at the surface. The effective refractive-index of the sensor changes in the event of binding of an analyte to the sensor surface or of ad-layer formation at the sensor surface. This can be monitored by the abovementioned systems.

In SPR sensors, the relative position of a sharp decrease or ‘dip’ in the intensity of light which is reflected at a thin metal surface is detected. In WGG and BG sensors, the relative position of an increase or ‘peak’ (also dip, depending on the measurement configuration (transmission/reflection)) in the intensity of light which is coupled into a waveguide is detected. The position of this dip/peak depends not only on the quantity of bound biomolecules, but also on other factors such as the wavelength of the incident light, bulk refractive index of the cover liquid, temperature and sensor material properties.

SPR, BG and/or WGG systems rely on various sensing configurations:

Most frequently, a monochromatic light source is used and the angular shift of the SPR minimum (dip) detected. Another, more primitive setup, measures the intensity of the reflected light at a fixed angle, which changes when the SPR curves shifts. Finally, one can exploit the wavelength dependency of the SPR phenomenon, irradiate the chip surface with white light at a fixed angle and detect the wavelength at which the resonance occurs. In this case, the shift occurs not in the resonance angle, but in the emitted wavelength upon a binding event at the sensor chip surface. Other configurations are feasible.

Amongst other, WGG sensors rely on the same detection modes as the abovementioned for SPR, but instead of a metal surface, one illuminates a waveguide grating structure in a dielectric substrate. The latter is responsible to couple the light into a waveguide and thereinafter to couple the light out onto a photo sensor to monitor the coupling efficiency. Light will only be coupled into the waveguide at the so called resonance conditions, given by several parameters like the grating structure, substrate and waveguide material and thickness, wavelength, polarization and angle of the incident light. The resonance conditions change as the effective refractive-index at the sensor surface changes due to bulk refractive-index changes or due to adsorption of molecules. These refractive-index changes can be interrogated by monitoring the maximal coupling efficiency versus coupling angle and/or wavelength for WGG and SPR and angle of deflection for TIR.

BG sensors rely on similar sensing principles as the abovementioned methods. Due to changes of the effective refractive index at the BG itself, the transmission and/or reflection spectrum of the latter one change. These changes or spectral shifts can either be monitored by a broadband optical spectrum analyzer or be interrogated by a tunable light source. Often, BGs are implemented in optical fibers and form a so called fiber Bragg grating sensor.

There is therefore a need for a method which overcomes the two problems of optical “refractive index change” detection systems, i.e. their sensitivity to external parameters such as temperature, pressure and their limited dynamic range. This is the objective of the present invention.

According to the present invention a detection system is used that is designed as to produce a plurality of signals (two or more) generated by the same illuminated area of the optical sensing region and detected quasi simultaneously for a certain period on the same detector to enhance the quality of the detected signal and/or its dynamic range.

The two or more sensing peaks can be for example produced by partly coating the illumination area of an optical sensor so as to produce

a. two sensing signals generated by the same illuminated area of the optical sensing region and detected quasi simultaneously for a certain period on the same detector and

b. one independent of surface effects, the second sensitive to surface effects allowing correcting for unwanted effects such as drift issues, temperature fluctuations, pressure changes.

By computing the difference between these two signals, one produces a, e.g. temperature, pressure, independent signal that monitors only e.g. the ad- and desorption of the molecule on the surface of the sensor. The novelty lies in the differential sensing scheme obtained by monitoring several sensing peaks generated by the same illuminated area of the optical sensing region and detected quasi simultaneously for a certain period of time on the same detector with similar or independent sensitivities towards coupled or decoupled parameters.

The two or more sensing peaks can be for example produced by designing a resonant cavity with multiple modes and monitoring the sensing signal peaks generated by the same illuminated area of the optical sensing region and detected on the same detector quasi simultaneously for a certain period of time as they move across the detection window. By correlating the second to the first peak while in the detection window, one can extend the dynamic range of the system from the dynamic range of one peak to the dynamic range of two peaks increasing the dynamic range of the system beyond the dynamic range obtained from a single peak.

In other words according to state of the art, the detection window is chosen in such a way, that only one peak can be detected. According to one aspect of the present invention, the detection window is chosen in such a way that at least for a specific value of the parameters to be measured two peaks are present within the detection window. The first peak has not yet left the detection window, i.e. is still present therein, whereas the second peak already entered the detection window, i.e. is already present therein. From the position of the first peak the actual value of the parameter to be measured is known. Therefore this value can be attributed to the position of the second peak. If there is a change in the value of the parameter to be measured the change is known as the first peak will shift in a known way. The second peak is shifting as well and the therefore it is now known what value change causes what shift for the second peak. If now the value of the parameter to be measured changes in such a way that the first peak shifts out of the detection window, the second peak will shift further into the detection window and the value change can be calculated on the basis of the shift of the second peak. Accordingly the dynamic range of the detection system is no more limited to the first peak remaining within the detection window but increased to the second peak shifting within the detection window. It is clear that the respective method can be generalized to a multitude of peaks.

These differential sensing schemes allow for increased sensitivity and/or dynamic range in optical “refractive index change” biosensing.

According to the present invention in a multi-peak detection method of an optical detection system the same detector is used to detect a plurality of (at least two) peaks for enhanced detection, the method comprising:

a. Tracking the change of at least one parameter of one peak in the detection range as a function of time

b. Tracking the change of at least one parameter of at least one second peak in the detection range as a function of time quasi simultaneously for a certain period p c. Correlating the signal of the at least two peaks to generate a combined signal as a function of time

d. Outputting the combined signal generated by the at least two peaks.

By using a plurality of peaks for detecting, the dynamic range of the optical detection system is increased.

If one of the peaks results from an area not exposed to value change of the parameter to be measured its detection provides a reference signal for the optical detection system

The method according to one aspect of the invention comprises the following steps:

a. Recording at least one parameter with one first peak with at least one optical detector

b. Recording with the same at least one optical detector the at least one parameter of with at least one second peak quasi simultaneously for a certain period of time

c. Correlating with a signal processing unit the one first and the at least one at least one second peak and relating it to the at least one parameter and/or its value and/or value change.

Preferably the signal processing unit is delivering the combined signals of the at least one parameter of one first and the at least one parameter of the at least one second peak

Once the combined signals are related to the parameter values, the use of a plurality of peaks detection increases the dynamic range of the optical detection system as in further measurements only one peak needs to be within the detection window in order to measure the value of the parameter to be measured and its change.

According to another aspect of the present invention the use of a plurality of peaks detection where at least one of the peaks provides a reference signal for the optical detection system.

In case of an optical detection system and if there is a light source used, the respective wavelength and/or the incident angle of the light on the optical elements may be varied in time. It is as well possible to vary the intensity of the light. If the angle of incidence is changed, this might be accomplished by one or a multitude of scanning mirrors. For example microelectromechanical scanning mirrors may be used. The same is possible for the outgoing light. One measurement parameter might be for example the intensity of reflected light, which could be for example outcoupled or outgoing light in general.

As light source a tunable light source may be used. As detector a tunable detector such as a spectrophotometer may be used.

The present invention relates to a novel “refractive index change” detection method and system that uses a plurality (at least two) of signals generated by the same illuminated area of the optical system and detected quasi simultaneously for a certain period on the same detector to enhance the quality of the signal and/or its dynamic range. Within the framework of this patent application “the same detector” shall mean detection is performed on a single unique element in contrast to for example to pixels of a linear CCD detector. In particular, the plurality of signals may be generated by a multi-mode resonant cavity or by a partially coated surface. By using differential sensing schemes, the computed output signal can be rendered more or less sensitive to ad- and desorption of (bio) chemical substances, pH, stress/strain or temperature as well as pressure and polarization.

The main two application domains are correction for unwanted effects such as drift issues, temperature fluctuations, pressure changes or increased dynamic range by correlating successive signal peaks in the detection window. However, the invention is not restricted to those main applications.

The present invention will be described in more detail below with the help of the following Figures.

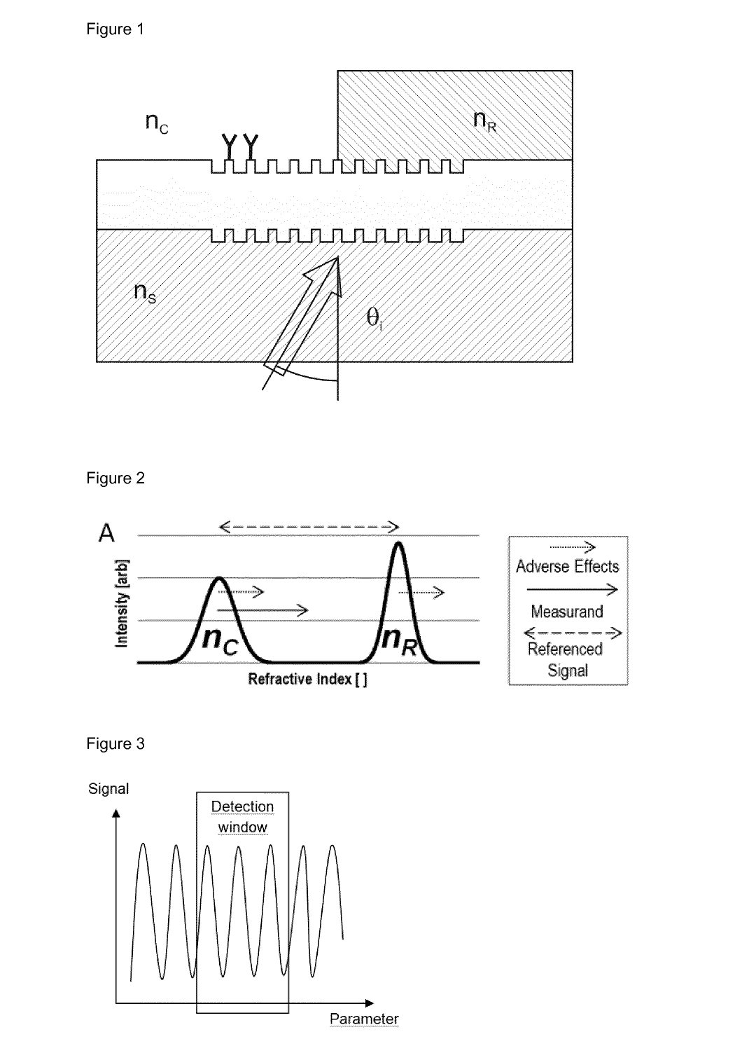

FIG. 1 shows a partially coated WGG based sensor;

FIG. 2 shows two peaks of the sensor in FIG. 1;

FIG. 3 shows the detection window with multiple modes of a resonant cavity;

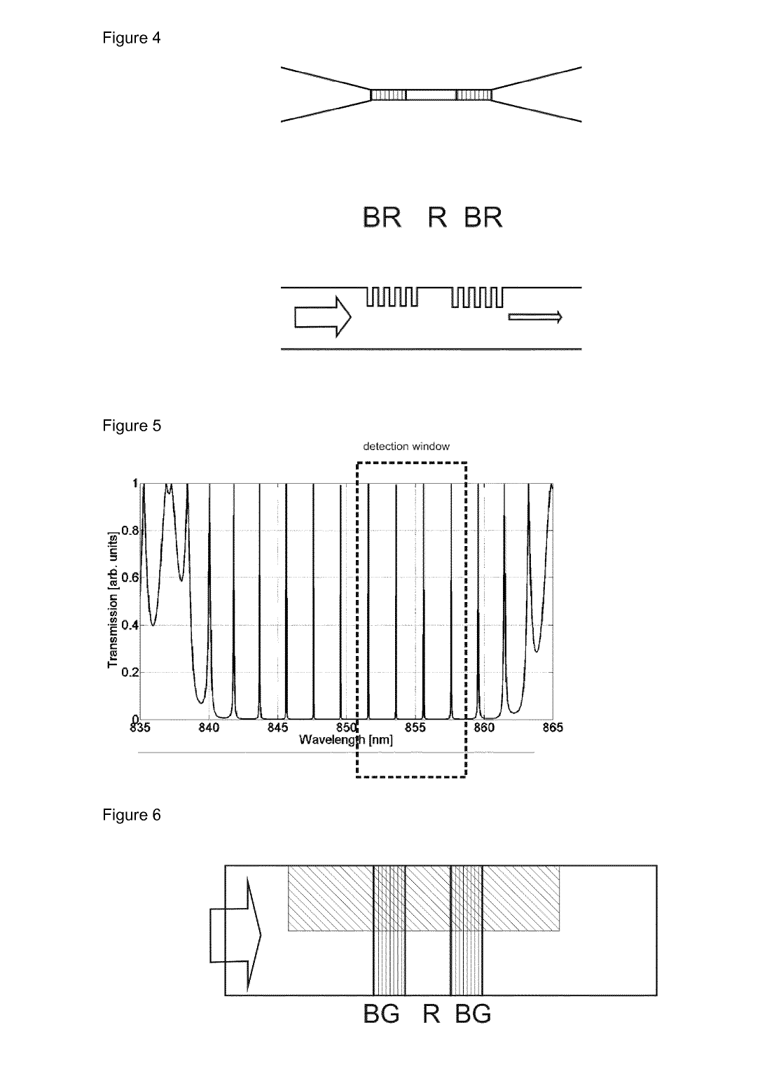

FIG. 4 shows a first view and a second view of an optical resonator;

FIG. 5 shows the peaks of the optical resonator of FIG. 4; and

FIG. 6 shows a variation of the optical resonator of FIG. 4.

It is understood that the various embodiments, preferences and ranges as provided/disclosed in this specification may be combined at will. Further, depending of the specific embodiment, selected definitions, embodiments or ranges may not apply.

A first example relates to the design and use of an “refractive index change” optical detection system for the detection of the effective refractive index and/or attenuation at or near the interface of the sensor, e.g. of refractive index changes of liquids on the surface, or for the detection of ad- and desorption of (bio)chemical substances and/or pH changes or for the detection of ad- and desorbed (bio)chemical, as well as monitoring of stress/strain and temperature acting on the sensing device.

An example is given to produce a plurality of signals generated by the same illuminated area of the optical sensing region and detected simultaneously or quasi simultaneously for a certain period on the same detector.

According to this example the illumination area (sensitive area) of a WGG based sensor is partially coated as shown in FIG. 1 below with a material of known or unknown optical and thermal properties. This constitutes a self-referencing system. FIG. 1 is a schematic representation of the self-referencing system. Shown is the cross-section of the sensor element, partly covered by a material with refractive index n_{R}. As illustrated in FIG. 2. whereas adverse effects influence the position of the resonance peaks for n_{C} and n_{R}, only the n_{C} peak shifts due to the change of the superstate's refractive index or molecule (Y) adsorption.

As can be seen, the previously uncoated sensing region upon coating will be inherently split into two distinct regions. The coated region acts as a reference region for the uncoated sensing region. External drifts, noises and disturbances will influence both sensing regions equally, whereas refractive index changes of the cover solution (due to its inherent properties or due to the absorbance of molecules) will only influence the uncoated region. The coating of the coated region acts as a cover, hence refractive index changes in the cover solution do not affect the coated reference region. Differential monitoring of the two signals (e.g. position of optical resonance peak) will lead to an improved signal quality. One main embodiment of the present invention is to self-reference one sensing element by itself instead of employing an additional measurement channel.

By computing the difference between these two signals, one produces a signal independent of e.g. temperature, pressure, that monitors only e.g. the ad- and desorption of the molecule on the surface of the sensor. The measurements are improved due to the differential sensing scheme obtained by monitoring several sensing peaks generated by the same illuminated area of the optical sensing region and detected quasi simultaneously for a certain period of time on the same detector with similar or independent sensitivities towards coupled or decoupled parameters.

According to another example of the present invention a single Bragg grating is foreseen in a slab waveguide. The waveguide could be realized by a Ta2O5 layer which is 85 nm thick. The Bragg grating has a period of 272 nm and a modulation height of 15 nm. The Bragg grating constitutes a filter which blocks a wavelength interval something between 835 nm and 865 nm. The edges of this blocked interval can be detected. If the steepness of filter characteristic is detected, the edges constitute a peak in the sense of this invention. The Bragg grating in this example is part of the sensing area. If the index of refraction of the environment changes, there will be a wavelength shift of the edges of the filter. It is a known sensing method to measure such shift. If according to the invention a part of the grating lines of the Bragg grating is covered by a passivation layer, such as for example a SiO2 layer, this part will no longer be sensitive to environmental changes in index of refraction. There will be two signal peaks and change of the distance in position of these two signal peaks refer to the change of refractive index.

A further example is related to another aspect of the present invention. According to this example a resonant cavity is designed with multiple modes as shown in FIG. 3 below. Even though the interrogation range of the optical system is limited, the apparent dynamic range can be bigger thanks to multiple peak detection. If one of the peaks shifts out of the interrogation range (e.g. due to an effective refractive index change of the optical transducer), a new one appears in the interrogation range and can be tracked.

By correlating the second to the first peak while in the detection window, one can extend the dynamic range of the system from the dynamic range of one peak to the dynamic range of two peaks increasing the dynamic range of the system beyond the dynamic range obtained from a single peak.

This could be for example realized by an integrated optical waveguide sensor system which is based on a pair of Bragg Gratings (BGs) spaced apart for the detection of the effective refractive index and/or attenuation at or near the interface of the sensor. The Bragg gratings are spaced apart in such a way that together with the waveguide they form an optical resonator.

A schematic view of such an optical resonator is shown in FIG. 4 in top view as well as in a cross section. From the top view it can be seen that in this example a tapered waveguide is used to guide light to the first Bragg Gratings. A spacing region R is foreseen between the two Bragg Gratings. By this a Fabry Perrot Resonator is established.

In the following a concrete example of such a resonator is given: The substrate of the example of the resonator to be described here is a Schott D263T glass plate with an index of refraction of n_{S}=1.5156. This substrate is covered by a Ta₂O₅ layer which is 85 nm thick and which has an index of refraction of n_{f}=2.097. Into this layer first and second rectangular surface gratings are etched which have a height of 15 nm, a grating period of 272 nm and a length of 50 μm each. These surface gratings form the Bragg gratings and they are spaced apart by 100 μm. Between the first and the second Bragg grating and with the exception of a ridge with a width of 5 μm, the Ta2O5 layer height is reduced by 15 nm. The resulting ridge forms together with the Bragg gratings the resonator as discussed above.

In order to produce such a waveguide system, first, the substrate (Schott D263T) is cleaned.

Then, the thin film deposition of the Ta2O5 waveguide layer is done for example by the use of a reactive sputtering system. Next, a photoresist (positive photosensitive) is deposited on the waveguide layer, e.g. by spin coating. The next step contains the photoresist exposure through the different masks in order related to Bragg gratings and the ridge. Appropriate alignment marks are required for this step. The fifth step contains the photoresist development. In this step, the photoresist at the locations which were not exposed will be removed. Following to this, the thin film will be etched by a dry etching process. Due to the sensor parameters, e.g. equal values for ridge height, grating depth and taper height, only one etch step is needed. Finally, the remaining photoresist is stripped off and the device cleaned.

FIG. 5 shows the optical response of such a resonator. Shown as well is a potential detection window. The detection window is chosen in such a way that a first peak is close to one end of the window within the window and a second peak is close to the other end of the window within the window so that for large value changes one of the signal peaks shifts out of the window. As can be seen from the figure as well, there can be multiple other peaks between the first and second peak.

With such a resonator as discussed above it is even possible to combine both aspects of the present invention. The resonator could be for example formed as described above, however not in a ridge waveguide version but in a slab waveguide version. Half of the width of this resonator could be passivated with the help of a passivation layer. The optical response would then be again something corresponding to FIG. 5, however with a second group of peaks. If the value of the parameter—such as for example the index of refraction of the cover medium in the sensing area which is not passivated—changes, the distance of the first group of peaks to the second group of peaks will change. This can be measured and calculated back to change of value of the parameter to be measured.

According to the present invention a method for measuring a value change of a parameter at the sensing area of an optical sensor element is disclosed in the present description, such method comprising the steps:
changing the value of the parameter thereby detecting the position and position change of a first signal peak within the detection window of a detector as well as thereby detecting the position and the eventual position change of a second signal peak within the detection window of the detector
correlating the position detections of first and second signal peak and correlating the position change detections of first and second signal peak and attributing a value and/or a value change to the correlated detections.

The second signal peak may results from a passivated part of the sensing area and as a consequence the value change of the parameter has no influence on the position of the second peak such second peak therefore serving as reference.

The optical sensor element used can be a waveguide grating element.

The optical sensor element used can be a waveguide with a single Bragg grating forming an optical filter and the signal measured is the slope of the optical filter.

Preferably the detection window is chosen in such a way that the first peak is close to one end of the window within the window and the second peak is close to the other end of the window within the window so that for large value changes one of the signal peaks shifts out of the window.

The optical sensor can comprise a Farbry Perrot Resonator formed by a waveguide and two Bragg gratings spaced apart. It is possible to passivate part of the spacing between the Bragg gratings is passivated thereby forming a passivated resonator neighboring a non passivated resonator.

What is claimed is:

1. Method for measuring a value change of a parameter at the sensing area of an optical sensor element such method comprising the steps:
detecting a position of a first signal peak and a second signal peak simultaneously within the detection window of a detector, wherein the first signal peak and the second signal peak are generated by the same illuminated area of the optical sensor element
measuring a value of a parameter from the position of the first signal peak;
attributing the value of the parameter to the second signal peak; and
calculating the value change of the parameter on the basis of the shift of the second signal peak, if the value of the parameter changed in such a way that the first signal peak shifted out of the detection window.

2. (canceled)

3. (canceled)

4. (canceled)

5. Method according to claim 1, characterized in that the detection window is chosen in such a way that at least for a specific value of the parameter, the first signal peak is close to one end of the detection window within the detection window and the second signal peak is close to the other end of the detection window within the detection window so that it is possible for large value changes that one of the signal peaks shifts out of the detection window.

6. Method according to claim 1 characterized in that the optical sensor element comprises a Farbry Perrot Resonator formed by a waveguide and two Bragg gratings spaced apart.

7. Method according to claim 3 characterized in that part of the spacing between the Bragg gratings is passivated thereby forming a passivated resonator neighbouring a non-passivated resonator.

8. Apparatus for measuring a parameter comprising:
an optical sensor element;
a detector for detecting a position of a first signal peak and a second signal peak simultaneously within a detection window of the detector, wherein the first signal peak and the second signal peak are generated by the same illuminated area of the optical sensor element, wherein the apparatus is further configured to measuring a value of a parameter from the position of the first signal peak, to attributing the value of the parameter to the second signal peak and to calculating the value change of the parameter on the basis of the shift of the second signal peak, if the value of the parameter changed in such a way that the first signal peak shifted out of the detection window.
